(19) United States
(12) Patent Application Publication
(10) Pub. No.: US 2007/0016857 A1
(43) Pub. Date: Jan. 18, 2007

(54) Method and system for non-intrusive portlet rendering for printing

(75) Inventors: Kenneth Eugene Polleck, Raleigh, NC (US); Varadarajan Ramamoorthy, Cary, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/170,865

(22) Filed: Jun. 30, 2005

(51) Int. Cl. G06F 17/00; G06F 15/16; G06F 3/00

(52) U.S. Cl. 715/530; 715/764; 709/203

(57) ABSTRACT

A system for printing data in a portlet. A portal server receives a request for a portal page from a requestor. In response to receiving the request for the portal page, the portal server retrieves the portal page, which includes a set of portlets. Subsequent to retrieving the portal page, the portal server renders an appearance that includes a print control for each portlet in the set of portlets. The print control is used to control a print functionality when the print control is manipulated by a user input. The print functionality is inserted into the retrieved portal page by the portal server to form a modified portal page. After the portal server modifies the portal page by rendering an appearance and inserting a print functionality, the portal server sends the modified portal page to the requestor.

### BACKGROUND OF THE INVENTION

1. Field of the Invention

The present invention relates to an improved data processing system. More specifically, the present invention is directed to a method, apparatus, and computer usable code for printing data in a portlet.

2. Description of the Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called transmission control protocol/Internet Protocol (TCP/IP).

The Internet has revolutionized communications and commerce, as well as, being a source of both information and entertainment. For many users, email is a widely used format to communicate over the Internet. Additionally, the Internet is also used for real-time voice conversations.

With respect to transferring data over the Internet, the World Wide Web environment is used. This environment is also referred to simply as “the Web”. The Web is a mechanism used to access information over the Internet. In the Web environment, servers and clients effect data transaction using the hypertext transfer protocol (HTTP), a known protocol for handling the transfer of various data files, such as text files, graphic images, animation files, audio files, and video files.

On the Web, the information in various data files is formatted for presentation to a user by a standard page description language, the hypertext markup language (HTML). Documents using HTML are also referred to as Web pages. Web pages are connected to each other through links or hyperlinks. These links allow for a connection or link to other Web resources identified by a universal resource identifier (URI), such as a uniform resource locator (URL).

A browser is a program used to look at and interact with all of the information on the Web. A browser is able to display Web pages and to traverse links to other Web pages. Resources, such as Web pages, are retrieved by a browser, which is capable of submitting a request for the resource. This request typically includes an identifier, such as, for example, a URL. As used herein, a browser is an application used to navigate or view information or data in any distributed database, such as the Internet or the World Wide Web. A user may enter a domain name through a graphical user interface (GUI) for the browser to access a source of content. The domain name is automatically converted to the IP address by a domain name system (DNS), which is a service that translates the symbolic name entered by the user into an IP address by looking up the domain name in a database.

The browser includes a user interface, which is a GUI that allows the user to interface or communicate with another browser. This interface provides for selection of various functions through menus and allows for navigation. For example, a menu may allow a user to perform various functions, such as saving a file, opening a new window, displaying a history, and entering a URL.

With respect to obtaining information on the Internet, portal based user interfaces are becoming increasingly popular because these types of interfaces allow the user to see user interfaces, also referred to as portlet windows, which gather data from many different sources going into a single HTML page. Portlets are an encapsulation of content and functionality used to present information to users on the Internet. Portlets are reusable components that combine Web-based content, application functionality, and access to resources. Portlets are assembled into portal pages that, in turn, make up a portal implementation. Portlets are similar to windows based applications in that they present their contents in a window-like display on a portal page. Thus, a portlet window is the outward manifestation of the portlet program. In other words, a portlet window is a graphical representation of the portlet's content on a browser. Like a windows based application, the portlet window has a title bar, which contains controls allowing the users to expand or maximize and shrink or minimize the application.

The portlet program may obtain the desired Web content from an appropriate content provider and aggregate the Web content. Each portlet coordinates with the portal to generate markup language content such that Web content is displayed in the appropriate portlet windows or subwindows. This markup language content includes, for example, HTML. This portal technology has lead to the explosion of personalized “home pages” for individual Web users.

Web portals provide a high degree of integration of disparate applications on a client Web browser. A typical portal page includes banner and navigation regions as well as five or more regions occupied by portlets. However, when an end user desires to print a hardcopy of something from a Web portal, the end user wants only to print the content of an individual portlet rather than the entire browser window that includes other portlets, the banner, and navigation bar. Currently, no mechanism exists to provide the ability to print the content of a single portlet without impacting the state of the portal page and without requiring additional network and portal server resources.

One existing approach to printing the content of a portlet requires a round-trip request to the portal server consuming processor and network resources. This existing approach may impact an end-user's productivity by increased printing time, especially on a slow network. Also, with this approach, a portlet programmer is explicitly required to program the print mode. While this mechanism may have the benefit of giving the programmer complete control over the resulting printed content, this mechanism will require additional Java™ programming and must be enabled on all portlets contained in the portal page in order to be able to print the content of those portlets. Furthermore, this approach requires a change in the mode of, the portlet which may require additional Java™ programming to return to the previous mode, which in turn, may require additional backend database calls consuming additional processor and network resources.

A second existing approach to printing the content of a portlet may offer a “printer-friendly view” button, which renders the current portal page without header and navigational information. However, this approach has the same limitations as the other existing approach. Also, the second approach involves the portal server rendering the entire portal page in a printer-friendly view rather than individual regions of the screen.

Yet, another existing approach may divide the portal page into frames, which may allow each frame to be printed individually using the Web browser's print function. While this third existing approach has been used by some Web sites previously, this existing approach is no longer common because this approach created problems with frames located within frames.

Still yet another existing approach is for a portlet programmer to use <div> tags to highlight the portlet content to be printed, which is a subset of embodiments of the present invention. However, <div> tags require custom programming in the JavaServer Page™ (JSP) and the need for custom programming does not extend well to enabling the <div> tags on all portlets on a portal page, such as, for example, pre-built portlets that the portal administrator may not have access to the source.

All of these currently used approaches require additional network, portal server, and/or programming resources.

### BRIEF SUMMARY OF THE INVENTION

Embodiments of the present invention provide a method, apparatus, and a computer usable code for printing data in a portlet. A portal server receives a request for a portal page from a requestor. In response to receiving the request for the portal page, the portal server retrieves the portal page, which includes a set of portlets. Subsequent to retrieving the portal page, the portal server renders an appearance that includes a print control for each portlet in the set of portlets. The print control is used to control a print functionality when the print control is manipulated by a user input. The print functionality is inserted into each portlet contained within the retrieved portal page by the portal server to form a modified portal page. After the portal server modifies the portal page by rendering an appearance and inserting a print functionality, the portal server sends the modified portal page to the requestor. The portal server, by rendering the appearance and inserting the print functionality in each portlet contained within the retrieved portal page, allows an end user to print the content of one or more individual portlets contained within the retrieved portal page without using portal server resources.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and benefits thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system is shown in which aspects of the present invention may be implemented;

FIG. 3 is a block diagram illustrating a portal server communicating with a client browser in accordance with an exemplary embodiment of the present invention;

FIG. 4 is an exemplary pictorial illustration of a generic portal page in accordance with an embodiment of the present invention;

FIG. 5 is a pictorial illustration of a specific portal page in accordance with an exemplary embodiment of the present invention;

FIG. 6 is an exemplary pictorial illustration of a specific portlet in accordance with an embodiment of the present invention;

FIG. 7 is a flowchart illustrating an exemplary process for a portal server in accordance with an embodiment of the present invention;

FIG. 8 is a flowchart illustrating an exemplary process for a client browser in accordance with an embodiment of the present invention; and

FIG. 9 is an exemplary script for print function invocation in accordance with an embodiment of the present invention.

### DETAILED DESCRIPTION OF THE INVENTION

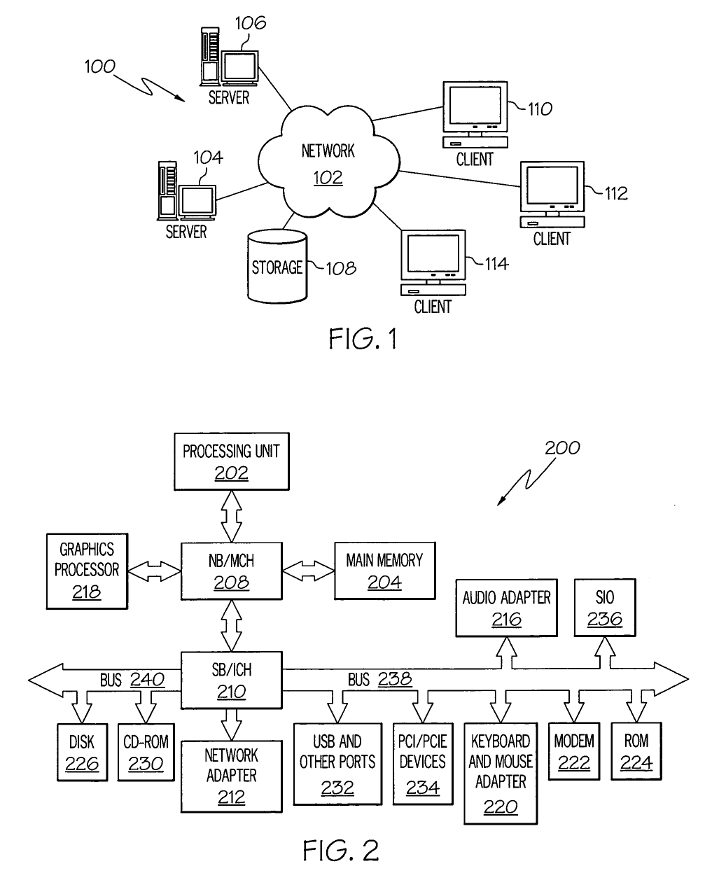

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 108 in FIG. 1, in which computer usable code or instructions implementing the processes for embodiments of the present invention may be located.

In the depicted example, data processing system 200 employs a hub architecture including north bridge and memory controller hub (MCH) 208 and south bridge and input/output (I/O) controller hub (ICH) 210. Processing unit 202, main memory 204, and graphics processor 218 are connected to north bridge and memory controller hub 208. Graphics processor 218 may be connected to north bridge and memory controller hub 208 through an accelerated graphics port (AGP).

In the depicted example, local area network (LAN) adapter 212, audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 210 through bus 238. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 210 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 210.

An operating system runs on processing unit 202 and coordinates and provides control of various components within data processing system 200 in FIG. 2. As a client, the operating system may be a commercially available operating system such as Microsoft Windows XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 202. Alternatively, a single processor system may be employed.

Instructions for the operating system, the object-oriented programming system, and applications or programs are located on storage devices, such as hard disk drive 226, and may be loaded into main memory 204 for execution by processing unit 202. The processes for embodiments of the present invention are performed by processing unit 202 using computer usable program code, which may be located in a memory such as, for example, main memory 204, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

As some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 204, read only memory 224, or a cache such as found in north bridge and memory controller hub 208 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Aspects of the present invention provide a computer implemented method, apparatus, and computer useable program code for printing data in a portlet. When a portal server receives a request for a portal page from a client browser, the portal server retrieves the requested portal page from a database, renders an appearance on each portlet contained within the requested portal page, and inserts in a skin tags and a functionality. A portal page is a Web “supersite” that provides a variety of services including, for example, Web searching, news, white and yellow pages directories, electronic mail, discussion groups, online shopping, and links to other sites. Although the term was initially used to refer to general purpose sites, the term “portal” may also be used to refer to other sites that offer a plurality of services, particularly those providing dynamic content.

The skin defines an appearance of the portlet. This appearance is how the portlet is presented to a user in a graphical user interface. In these examples, a skin dictates the appearance of a portlet in a Web page that is displayed using a browser. Also in these examples, the tags define the content of each portlet and the functionality is a print functionality. The print functionality allows an end user to print the content of the portlet by manipulating a print control through a user input. The print control may be included in the skin or appearance of the portlet. The print control may be, for example, a print icon or a print link.

However, embodiments of the present invention are not limited to rendering a skin and inserting tags and a functionality in each portlet. Other items may be rendered or inserted in each portlet in addition to, or in place of, the skin, the tags, and the functionality.

Subsequent to the portal server adding print function to each portlet while rendering the portal page and the portlets, the portal server sends the requested portal page over a network to the requesting client browser. In these examples, the print control is a print icon. Of course, other graphical controls, such as, for example, minimize, maximize, link, and help may be used. The portal server, by rendering an appearance and inserting tags, print control and print functionality in each portlet, allows an end user viewing the portal page on the client browser to print the content of one or more individual portlets contained within the requested portal page.

A benefit of an embodiment of the present invention may be that time spent by a portlet programmer is reduced because the programmer is not required to write programming code for each individual portlet print function. Another benefit of an embodiment of the present invention may be that the portal server is not required to use processor cycles for portlet printing. In addition, network resources are not used to perform the portlet print function. Consequently, print time may be reduced, especially during periods of network congestion, increasing end user productivity. Yet another benefit of an embodiment of the present invention is that only a portion of a portal page is printed. As a result, saving on printer resources, such as, paper, ink, and equipment wear and tear, is realized.

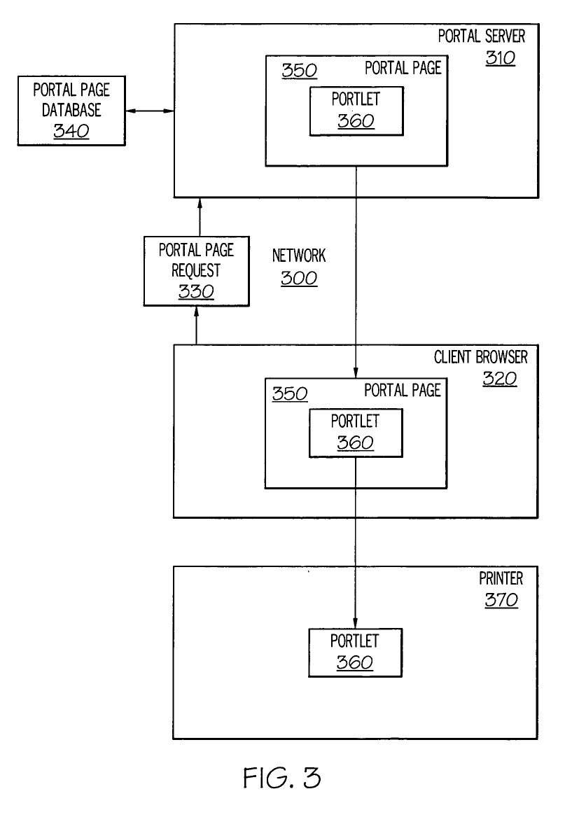

Turning now to FIG. 3, a block diagram illustrating a portal server communicating with a client browser is shown in accordance with an exemplary embodiment of the present invention. Portal server 310 provides content to client software, such as, client browser 320. Portal server 310 may be a Web server, such as, for example, server 104 in FIG. 1. A portal server is a network server that deploys portal services to a public Web site or internal intranet. A portal server may also refer to an application that is used to develop, deliver, and maintain portal services through a Web page. An example of a portal server that may be modified to be utilized by embodiments of the present invention is WebSphere Portal™, a product of International Business Machines Corporation in Armonk, N.Y.

Client browser 320 may be embodied on a data processing system, such as client 108 in FIG. 1, for example. A browser is a program used to look at and interact with information on a distributed database, such as the Web. A browser is able to display Web pages and to traverse links to other Web pages. A browser submits a request for resources, such as Web pages, and then retrieves the resources. A typical request includes an identifier, such as, for example, a URL. As used herein, a browser is an application used to navigate or view information or data in any distributed database, such as the Internet or the World Wide Web. A user may enter a domain name through a graphical user interface (GUI) for the browser to access a source of content. The domain name is automatically converted to the IP address by a domain name system (DNS), which is a service that translates the symbolic name entered by the user into an IP address by looking up the domain name in a database.

The browser includes a user interface, which is a GUI that allows the user to interface or communicate with another browser. This interface provides for a selection of various functions through menus and allows for navigation. For example, a menu may allow a user to perform various functions, such as saving a file, opening a new window, displaying a history, and entering a URL.

With respect to obtaining information on the Internet, portal based user interfaces are becoming increasingly popular because these types of interfaces allow the user to see user interfaces, also referred to as portlet windows, which gather data from many different sources going into a single hypertext mark-up language (HTML) page.

Portal server 310 retrieves portal page 350 from portal page database 340 in response to portal page request 330 sent from client browser 320. Alternatively, portal server 310 may retrieve portal page 350 from any source that supports portal pages, such as, another portal server connected to network 300, for example, network 102 in FIG. 1.

Subsequent to retrieving portal page 350 in response to portal page request 330, portal server 310 may modify portal page 350 before sending portal page 350 over network 300 to client browser 320. Portal page 350 contains portlet 360. A portlet is an encapsulation of content and functionality that may be used by a portal server to build a portal page. Portlets are Web components specifically designed to be aggregated in the context of a composite page. For example, a single portal page request may invoke seven to ten portlets. Portlet technology allows a portal page to be customized more quickly either internally by the development team or by an end user. Portlet technology may come as an adjunct to a portal server or as optional interfaces to enterprise resource planning (ERP) applications.

The degree of portlet customization also varies. As a typical example, an end user may customize a portal page to include a search engine portlet, a stock price portlet, a weather portlet, and a sports scores portlet. However, more application specific examples may also exist. For example, a portal page may provide monitoring services for network resources, where each portlet presents a particular monitor. When an end user requests a portal page through a browser, the portal server dynamically generates the portal page using the various portlets that make up the page. A portlet window is a graphical representation of the portlet's content and functionality on the browser.

After client browser 320 receives portal page 350, an end user may desire to print only portions of portal page 350, such as, for example, portlet 360. Embodiments of the present invention permit an end user to select and print portlet 360, or any other individual portlet that may be contained on portal page 350, without including other portal page 350 content or images not selected by the end user. Portal server 310 permits the end user to print a portlet by rendering a skin, which includes a print control, on each individual portlet.

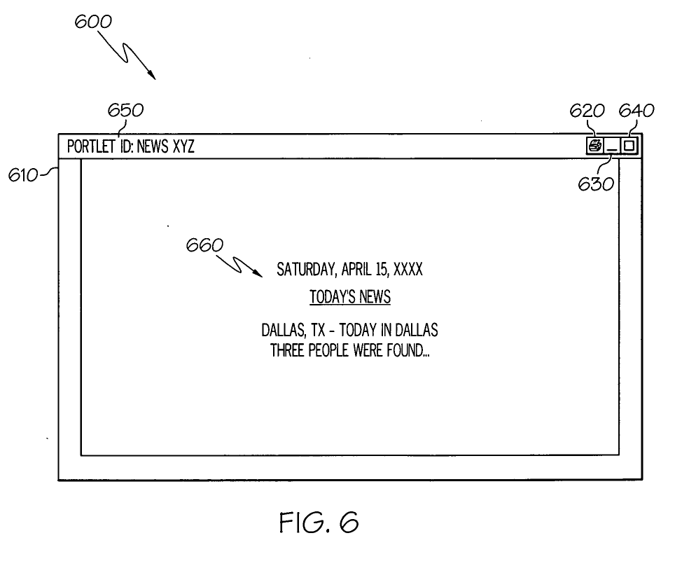

Additionally, portal server 310 inserts a print icon or link in the skin and inserts <div> tags, with a unique identifier, at the beginning and end of the portlet's content. The unique identifier identifies the portlet content when the end user clicks on the portlet's print icon or link. After the end user clicks on the portlet's print icon or link inserted in the skin of portlet 360, the content of portlet 360 is sent to printer 370 for printing. An embodiment of the present invention for printing a portlet contained within a portal page will be discussed in detail in the description of FIG. 6 below.

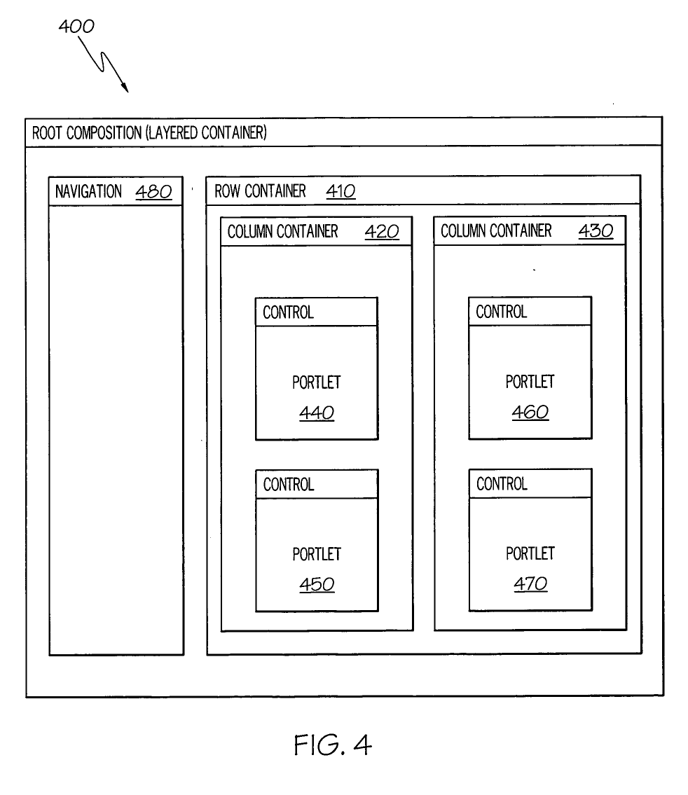

Referring now to FIG. 4, an exemplary pictorial illustration of a generic portal page is depicted in accordance with an embodiment of the present invention. Generic portal page 400 may have the following layout: row container 410, which contains: column container 420 and column container 430. Column containers 420 and 430 may each contain two portlet containers. A portlet container runs portlets and provides the portlets with the required runtime environment. Also, a portlet container provides persistent storage for portlet preferences and manages the portlets' lifecycle.

Even though generic portal page 400 is depicted with one row container, row container 410, and two column containers, column containers 420 and 430, embodiments of the present invention are not limited to such. The number and placement of row containers and column containers within portal page 400 may be modified as needed. Generic portal page 400 may be, for example, portal page 350 in FIG. 3.

The two portlet containers included within column container 420 and column container 430 may contain portlets 440, 450, 460, and 470, respectively. Portlet 440 may be, for example, portlet 360 in FIG. 3. In addition, generic portal page 400 may contain navigation bar 480. A navigation bar is a set of buttons or graphic images that are typically arranged in a row or column used as a central point that links an end user to major topic sections on a Web site. Major topic sections may include, for example, home, features, downloads, support, online help, contact us, et cetera.

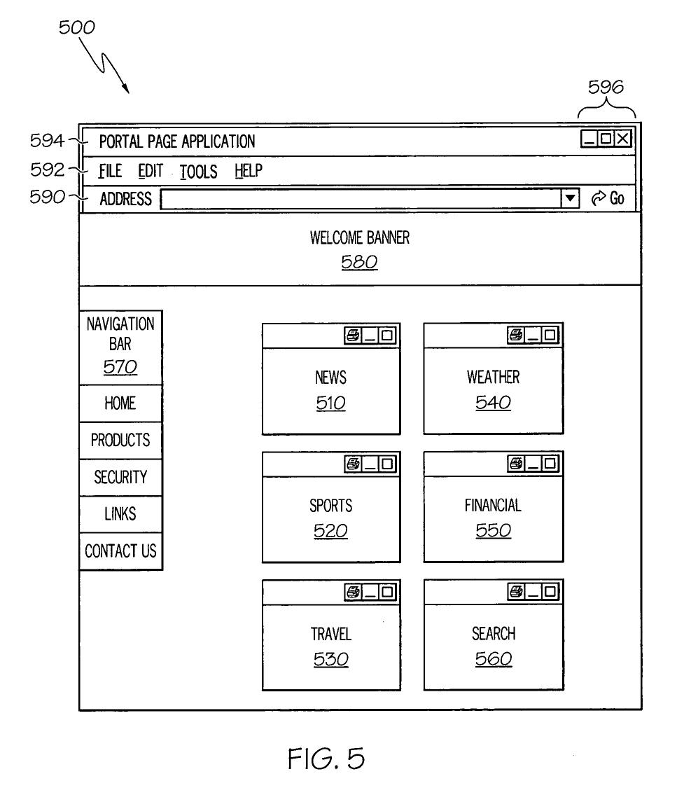

With reference now to FIG. 5, a pictorial illustration is shown of a specific portal page in accordance with an exemplary embodiment of the present invention. Portal page 500 may be, for example, portal page 400 in FIG. 4. Portal page 500 may contain, for example, news portlet 510, sports portlet 520, travel portlet 530, weather portlet 540, financial portlet 550, and search portlet 560. However, embodiments of the present invention may contain more or fewer portlets on portal page 500. In addition, embodiments of the present invention are not restricted to the above listed types of portlets. Portlets contained on a portal page may be of any type deemed necessary by the end user or portal server in accordance with embodiments of the present invention.

After reviewing portal page 500, an end user may desire to print news portlet 510. News portlet 510 may be, for example, portlet 440 in FIG. 4.

Embodiments of the present invention allow an end user to print the content of portlet 510, or portlets 520, 530, 540, 550, or 560, or any combination thereof, without including in the print job content or images not selected by the end user on portal page 500. Details for printing an individual portlet contained within a portal page will be discussed in the detailed description of FIG. 6 below.

Portal page 500 may also include navigation bar 570, for example, navigation bar 480 in FIG. 4, that contains links such as, home, products, security, links to other Web sites, and contact us. However, the preceding list is only exemplary and embodiments of the present invention are not restricted to such. Further, portal page 500 may also include, for example, items such as, banner 580, address bar 590, menu bar 592, and title bar 594, which also includes window menu 596. Window menu 596 may be utilized to minimize, maximize, or close portal page 500. However, embodiments of the present invention are not limited to the above mentioned items. Portal pages may contain, for example, any content, images, information, links, tools, or any combination thereof, for the purpose of utilizing the system of embodiments of the present invention.

Turning now to FIG. 6, an exemplary pictorial illustration of a specific portlet is depicted in accordance with an embodiment of the present invention. Portlet 600 may be, for example, news portlet 510 in FIG. 5. Portlet 600 may contain portlet skin 610. A theme determines the global appearance of a portal page. However, a portlet skin defines the appearance of a portlet. Portlet skins may be installed independently from a theme; however, a portlet skin may be associated with a theme.

Themes affect the navigational structure, the banner, the colors and fonts, the available portlet skins, and other visual elements of a portal page. A theme consists of resources, such as, JavaServer Page™ (JSP) files, style sheets, and images. A portlet skin typically consists of a set of JSP files. JSP is an extension to the Java™ servlet technology from Sun™ Microsystems, Inc. that allows HTML to be combined with JavaScript™ on the same page. JavaScript™ adds processing or interactive functions to HTML pages, which are otherwise static, since HTML is a display language, not a programming language. HTML provides the page layout, which will be rendered in a Web browser.

A portal server, such as, portal server 310 in FIG. 3, may assign, for example, different portlet skins to different portlets contained within a portal page, independent of each portlet. Also, the portal server may, for example, specify a global portlet skin default in the event a portlet skin is not assigned to a portlet. Further, in these examples, the portal server may add print functionality into the portlet skin. However, embodiments of the present invention are not limited to adding the print functionality into the portlet skin. The print functionality may be inserted into any portion of the portlet necessary to accomplish processes of embodiments of the present invention. Furthermore, the portal server may add controls in the portlet appearance, such as print, minimize, and maximize. For example, the portal server may insert within title bar 650 print icon 620, minimize icon 630, and maximize icon 640.

However, embodiments of the present invention are not limited to the insertion of icons into the portlet appearance, buttons, text, or any combination thereof may be added into the portlet appearance in order to incorporate controls in portlet 600. Furthermore, embodiments of the present invention are not restricted to the preceding list of portlet skin functionality and controls. Other functionalities and controls may be included in the portlet skin or appearance, such as, for example, link, edit, configure, and help.

The addition of the print icon in the portlet appearance extends the print control and function to each individual portlet contained within a portal page. Programming code for the portlet skin renders the portlet content. Modifying the portlet skin allows for the insertion of a print icon in the appearance of all portlets. The modified portlet skin may be configured to be a default skin for a portal page theme.

After the print icon is generated in the portlet appearance and the <div> tags are inserted at the beginning and end of the portlet content, print function interaction is between the end user and the browser. For example, when an end user manipulates a user input, such as manipulates a mouse to click on a portlet's print icon, the browser selects the portlet's content enclosed within the appropriate <div> tags and sends the selected portlet content for printing. In other words, a portal server request to prepare the selected portlet content for printing is not required. As a result, embodiments of the present invention allow the portal server to generate print icons in portlet appearance without changing the portlet programming code for each individual portlet during portlet rendering. This feature allows print rendering to be performed entirely by the client browser, such as, for example, client browser 320 in FIG. 3, without impacting the portlet state or portal server resources. Thus, the result is faster, non-portal server intrusive printing of the desired portlet information.

When the end user selects print icon 620, text 660 is sent for printing. Consequently, instead of an entire portal page, such as, portal page 500, containing numerous portlets, such as, portlets 510-560 in FIG. 5, being printed, wasting network bandwidth, processor resources, printer ink and paper, and time, only text 660 is printed. Therefore, only information of interest to the end user is printed.

Rendering of text 660 is accomplished via the use of <div> tags, which use a built-in JSP tag library to retrieve the portlet identification. An HTML tag is a code used in HTML to define a format change or hypertext link. HTML tags are surrounded by the “less than” and “greater than” symbols. A <div> tag defines a division or section of a document. A JSP tag library defines declarative, modular functionality that can be reused by any JSP page.

Title bar 650 may include, for example, a portlet name or title, a portlet identification number, graphic or image, or any combination thereof, for the purpose of identifying portlet 600. In this illustrated example, portlet 600 contains in title bar 650 the identification of Portlet ID: News XYZ. Consequently, the <div> tag may be, for example, defined as: <div id=“PortletID:NewsXYZprintMe”>. As a result, the portal server marks text 660 from the end of title bar 650 through the bottom of portlet 600. When the end user clicks on print icon 620, an onclick event is “fired,” such as, for example,

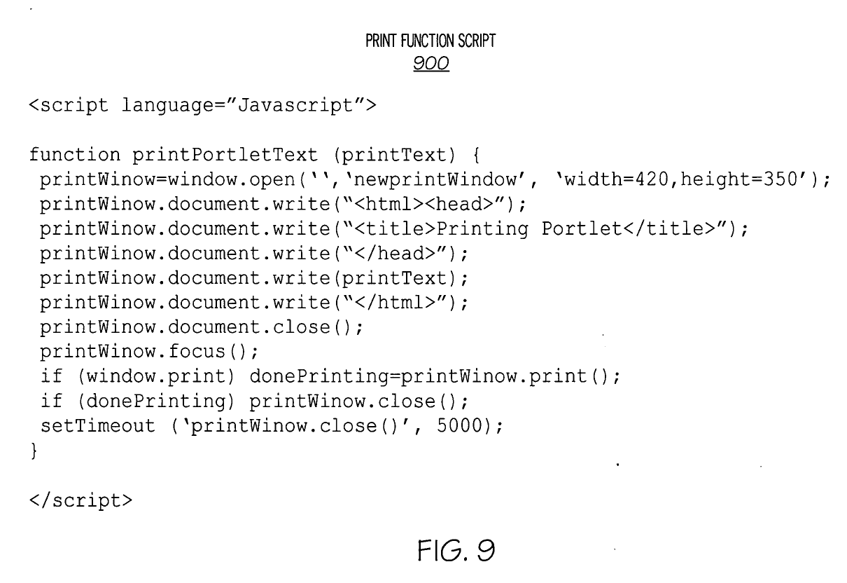

onclick=“printPortletText(document.getElementById(“Portle tID:NewsXYZprintMe”).innerHTML);return false”>. The fired onclick event invokes JavaScript™ to render text 660, which is the content of the <div> tag in this illustrated example, into a new browser window and also invokes the print function on the new browser window. Therefore, no individual portlet programming is required to add portlet-level print capabilities because an embodiment of the present invention inserts the print capability in the skin of each individual portlet contained within a portal page. An example of a JavaScript™ that may be utilized by embodiments of the present invention to perform the portlet print function is found in FIG. 9.

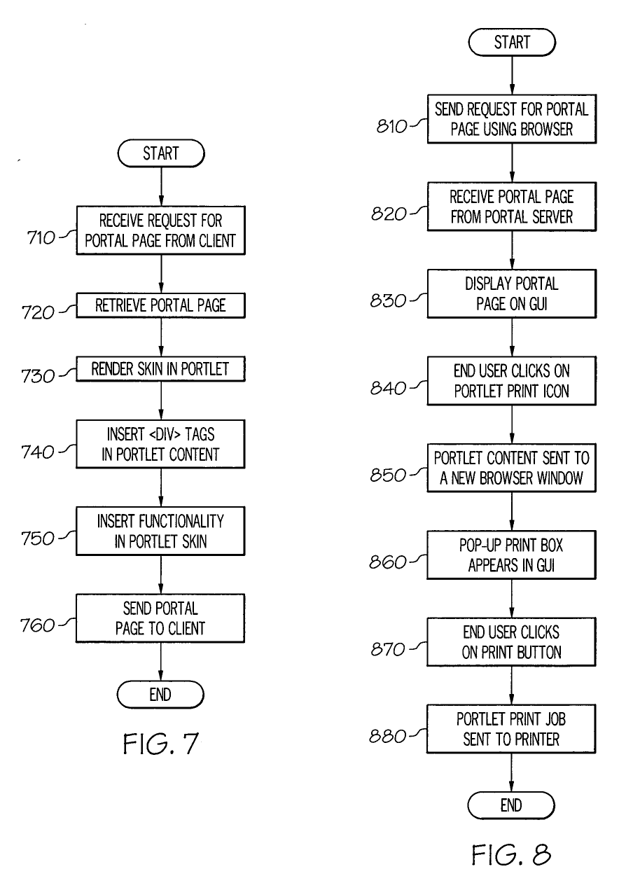

Referring now to FIG. 7, a flowchart is shown illustrating an exemplary process for a portal server in accordance with an embodiment of the present invention. The process illustrated in FIG. 7 may be implemented as a portal server, such as portal server 310 in FIG. 3.

The process begins when a portal server receives a request for a portal page from a client browser over a network (step 710). For example, portal server 310 receives portal page request 330 from client browser 320 over network 300 in FIG. 3. Subsequent to receiving the request for a portal page in step 710, the portal server retrieves the portal page from a portal page database (step 720). For example, portal server 310 retrieves portal page 350 from portal page database 340 in FIG. 3. However, embodiments of the present invention are not limited to retrieving a portal page from a database, any portal page source may be utilized. A portal page consists of one or more portlets, such as, for example, portlets 510-560 in FIG. 5. Portlets are data containers containing specific content and information.

After retrieving the portal page in step 720, the portal server renders an appearance, such as, skin 610 in FIG. 6, on each portlet contained within the portal page (step 730). The skin defines the appearance of the portlet. In addition, the skin renders the content of a portlet by inserting <div> tags at the beginning and end of the portlet's content (step 740). The <div> tags are used to define the content of each portlet, such as, for example, text 660 contained on portlet 600 of FIG. 6.

Further, the portal server may insert print functionality and a print control in the portlet skin (step 750). For example, a portal server may insert print icon 620 on portlet skin 610 in FIG. 6. However, embodiments of the present invention are not restricted to inserting a print icon on the portlet skin, a print link may be utilized as well. Further, other controls also may be inserted, such as, for example, minimize icon 630 and maximize icon 640 in FIG. 6.

Subsequent to the portal server rendering an appearance on the portlet, inserting <div> tags around the portlet content, and inserting print functionality and control in the portlet skin in steps 730, 740, and 750, respectively, the portal server sends the portal page over the network to the requesting client browser (step 760). For example, portal server 310 sends portal page 350 over network 300 to client browser 320 in FIG. 3. The process terminates thereafter.

With reference now to FIG. 8, a flowchart is depicted illustrating an exemplary process for a client browser in accordance with an embodiment of the present invention. The process illustrated in FIG. 8 may be implemented as a client browser, such as client browser 320 in FIG. 3.

The process begins when a client browser sends a request for a portal page over a network (step 810). For example, client browser 320 sends portal page request 330 to portal server 310 over network 300 in FIG. 3. In response to the request, the portal server sends the requested portal page, such as, for example, portal page 500 in FIG. 5, over a network to the client browser. The client browser receives the portal page from the portal server (step 820). For example, client browser 320 receives portal page 350 from portal server 310 in FIG. 3.

After the client browser receives the portal page in step 820, the client browser displays the portal page on a graphical user interface (step 830). An end user views the displayed portal page on the graphical user interface in step 830 and desires to print the content of a particular portlet contained on the portal page. For example, an end user wants to print text 660 contained on portlet 600 of FIG. 6. Portlet 600 may be a portlet, such as, news portlet 510 on portal page 500 in FIG. 5. The end user clicks on a print icon of the desired portlet (step 840). For example, an end user may use a mouse to point and click on a print icon, such as print icon 620 in FIG. 6.

Subsequent to the end user clicking on the print icon in step 840, the portlet content is sent to a new client browser window (step 850) and a pop-up print box then appears in the graphical user interface of the new client browser window (step 860). The end user clicks on the print button, which is contained within the pop-up print box of step 860 (step 870). After the end user clicks on the print button in step 870, the client browser sends the portlet print job to a printer for printing (step 880). For example, client browser 320 sends the content of portlet 360 to printer 370 for printing in FIG. 3. Embodiments of the present invention may utilize, for example, an attached default printer, a local area network printer, a wide area network printer, or any printer capable of printing the portlet content print job. The process terminates thereafter.

Turning now to FIG. 9, a script for print function invocation is shown in accordance with an exemplary embodiment of the present invention. A portal server locates the script for print function invocation within the contents of a portal page that is sent to a requesting client browser. For example, portal server 310 sends portal page 350 that contains JavaScript™ 900 to requesting client browser 320 in FIG. 3.

JavaScript™ 900 is presented only as an example of script that may be used by embodiments of the present invention to perform the portlet print function. Embodiments of the present invention are not restricted to the use of JavaScript™ 900. Any programming script may be employed by embodiments of the present invention that is capable of accomplishing the portlet print function.

Thus, embodiments of the present invention provide a method, apparatus and computer usable code for printing data in a portlet. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of embodiments of the present invention have been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for printing data in a portlet, the method comprising:
receiving a request from a requestor for a portal page to form a received request;
retrieving the portal page using the received request to form a retrieved portal page, wherein the retrieved portal page includes a portlet;
rendering an appearance for the portlet, wherein the appearance includes a print control in the portlet contained within the retrieved portal page;
inserting a print functionality into the portlet contained within the retrieved portal page to form a modified portal page, wherein the print control is used to control the print functionality to print data in the portlet when the print control is manipulated through a user input; and
sending the modified portal page to the requestor.

2. The computer implemented method of claim 1, wherein the steps are performed by a network portal server.

3. The computer implemented method of claim 1, wherein the requestor is a client browser.

4. The computer implemented method of claim 1, wherein the portal page is retrieved from a database.

5. The computer implemented method of claim 1, wherein tags are inserted into the retrieved portal page, and wherein the tags are <div> tags.

6. The computer implemented method of claim 5, wherein the <div> tags define a portlet content.

7. The computer implemented method of claim 1, wherein the appearance is a skin, and wherein the skin defines an appearance of the portlet.

8. The computer implemented method of claim 1, wherein the print control is at least one of a print icon and a print link.

9. The computer implemented method of claim 1, wherein the portlet is part of a plurality of portlets, and wherein the appearance is rendered for each portlet, and wherein the print functionality is inserted in each portlet.

10. The computer implemented method of claim 3, wherein the client browser performs the portlet rendering for printing.

11. A data processing system comprising:
a bus system;
a storage device connected to the bus system, wherein the memory includes a set of instructions; and
a processing unit connected to the bus system, wherein the processing unit executes the set of instructions to receive a request from a requestor for a portal page to form a received request; retrieve the portal page using the received request to form a retrieved portal page, wherein the retrieved portal page includes a portlet; render an appearance for the portlet, wherein the appearance includes a print control in the portlet contained within the retrieved portal page; insert a print functionality into the portlet contained within the retrieved portal page to form a modified portal page, wherein the print control is used to control the print functionality to print data in the portlet when the print control is manipulated through a user input; and send the modified portal page to the requestor.

12. The data processing system of claim 11, wherein the steps are performed by a network portal server.

13. The data processing system of claim 11, wherein the requestor is a client browser.

14. The data processing system of claim 11, wherein the portal page is retrieved from a database.

15. A computer program product for printing data in a portlet, the computer program product comprising:
a computer usable medium having computer usable program code embodied therein, the computer usable medium comprising:
computer usable program code configured to receive a request from a requestor for a portal page to form a received request;
computer usable program code configured to retrieve the portal page using the received request to form a retrieved portal page, wherein the retrieved portal page includes a portlet;
computer usable program code configured to render an appearance for the portlet, wherein the appearance includes a print control in the portlet contained within the retrieved portal page;
computer usable program code configured to insert a print functionality into the portlet contained within the retrieved portal page to form a modified portal page, wherein the print control is used to control the print functionality to print data in the portlet when the print control is manipulated through a user input; and
computer usable program code configured to send the modified portal page to the requestor.

16. The computer program product as recited in claim 15, wherein tags are inserted into the retrieved portal page, and wherein the tags are <div> tags.

17. The computer program product as recited in claim 16, wherein the <div> tags define the portlet content.

18. The computer program product as recited in claim 15, wherein the appearance is a skin, and wherein the skin defines an appearance of the portlet.

19. The computer program product as recited in claim 15, wherein the print control is at least one of a print icon and a print link.

20. The computer program product as recited in claim 15, wherein the portlet is part of a plurality of portlets, and wherein the appearance is rendered for each portlet, and wherein the print functionality is inserted in each portlet.
